(19) United States
(12) Patent Application Publication
(10) Pub. No.: US 2016/0253561 A1
(43) Pub. Date: Sep. 1, 2016

(54) FACE MOUNTED EXTREME ENVIRONMENT THERMAL SENSOR

(71) Applicant: BAE SYSTEMS INFORMATION AND ELECTRONIC SYSTEMS INTEGRATION INC., Nashua, NH (US)

(72) Inventors: Brian M. FOLEY, Nashua, NH (US); William R. SAMUELS, Wilton, NH (US); Aldridge G. SOWER, Boston, MA (US); John R. FRANZINI, Hollis, NH (US)

(21) Appl. No.: 15/027,036

(22) PCT Filed: Aug. 4, 2015
(86) PCT No.: PCT/US15/43589

§ 371 Date: Apr. 4, 2016

Related U.S. Application Data
(60) Provisional application No. 62/032,792, filed on Aug. 4, 2014.

(51) Int. Cl. G06K 9/00; H04N 5/33; A42B 3/28; G02B 27/01

(52) U.S. Cl. CPC G06K 9/00671; G02B 27/0172; G02B 27/0176; H04N 5/33; A42B 3/28

(57) ABSTRACT

A system is provided for the display of thermal data in a respiratory mask, the system comprising: a first respiratory mask frame; a lens disposed in the respiratory mask frame disposed in front of eyes of the user; a transparent display, being detachably mounted to the respiratory mask and displaying thermal imaging data.

### RELATED APPLICATIONS

This application claims the benefit of U.S. Provisional Applications No. 62/032,792, filed Aug. 4, 2014. This application is also related to U.S. application Ser. No. 13/833,172 filed Mar. 15, 2013. Each of these applications is herein incorporated by reference in their entirety for all purposes.

### FIELD OF THE INVENTION

The invention relates to sensors and more particularly to head mounted sensors used in extreme environments.

### BACKGROUND OF THE INVENTION

A number of thermal sensor systems are known which are used for various firefighting, military, and industrial purposes. Often these systems are hand held, encumbering the user, or are subject to other deficiencies including allowing smoke, particles and debris between the user's eye and the sensor unit display; lack of parallax correction; partial obstruction of vision of the applicant.

In response to this need, the applicant has developed a hands-free thermal sensor for use in various firefighting, military, and industrial purposes U.S. application Ser. No. 13/833,172, the contents of which are incorporated herein by reference, provides a dedicated display integrated into the lens of the mask.

A need still exists, however, for a way to overlap thermal imagery, telemetry data, or other useful situational data with visible imagery in situations that require full/partial facial protection from extreme environments. Such extreme environments may include heat, gases, chemicals, smoke and the like.

### SUMMARY OF THE INVENTION

One embodiment of the present invention provides a system for the display of thermal data in a respiratory mask , the system comprising: a first respiratory mask frame; a lens disposed in the respiratory mask frame disposed in front of eyes of the user; a transparent display, being detachably mounted to the respiratory mask and displaying thermal imaging data.

Another embodiment of the present invention provides such a system wherein the thermal data is provided to the transparent display by a thermal imaging camera disposed outside of the lens.

A further embodiment of the present invention provides such a system wherein the thermal imaging camera is head mounted.

Yet another embodiment of the present invention provides such a system wherein the thermal imaging camera is disposed on the frame.

A yet further embodiment of the present invention provides such a system wherein the transparent display receives the data wirelessly.

Still another embodiment of the present invention provides such a system further comprising a wired connection between the transparent display and a source for the thermal imaging data.

A still further embodiment of the present invention provides such a system further comprising a port through which the wired connection emerges from the mask.

Even another embodiment of the present invention provides such a system further comprising a closure to the port.

An even further embodiment of the present invention provides such a system wherein the wired connection is through the lens.

Still yet another embodiment of the present invention provides such a system wherein the wired connection is through the frame.

A still yet further embodiment of the present invention provides such a system wherein the fame is sealed to the user's face.

Still even another embodiment of the present invention provides such a system wherein the display displays information in addition to the thermal imaging data.

A still even further embodiment of the present invention provides such a system wherein the transparent display is configured to be detached from the first respiratory mask and attached to a second respiratory mask.

A still even yet another embodiment of the present invention provides such a system wherein the transparent display is detached form the first respiratory mask and attached to the second respiratory mask without modification of either the first or the second respiratory masks.

A still even yet further embodiment of the present invention provides such a system wherein the transparent display is disposed between at least one eye of a user and the lens.

Even yet another embodiment of the present invention provides such a system wherein the wherein the transparent display displays telemetry data.

An even yet further embodiment of the present invention provides such a system wherein the telemetry data is data selected from the group of data consisting of self-location data, breathing apparatus status, target location data, camera and display battery life, environmental data, and combinations thereof.

Even still another embodiment of the present invention provides such a system wherein the transparent display is disposed on a side of the lens opposite from a user's eye, and further comprising a compliant seal configured to conform to the lens and substantially exclude atmospheric contaminants between the display and the lens.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a block diagram illustrating a thermal imaging display system with an internal display and a wireless data link configured in accordance with one embodiment of the present invention.

FIG. 2 is a block diagram illustrating a thermal imaging display system with an internal display and a wired data link configured in accordance with one embodiment of the present invention.

FIG. 3 is a block diagram illustrating a thermal imaging display system with an external display and a wired data link configured in accordance with one embodiment of the present invention.

### DETAILED DESCRIPTION

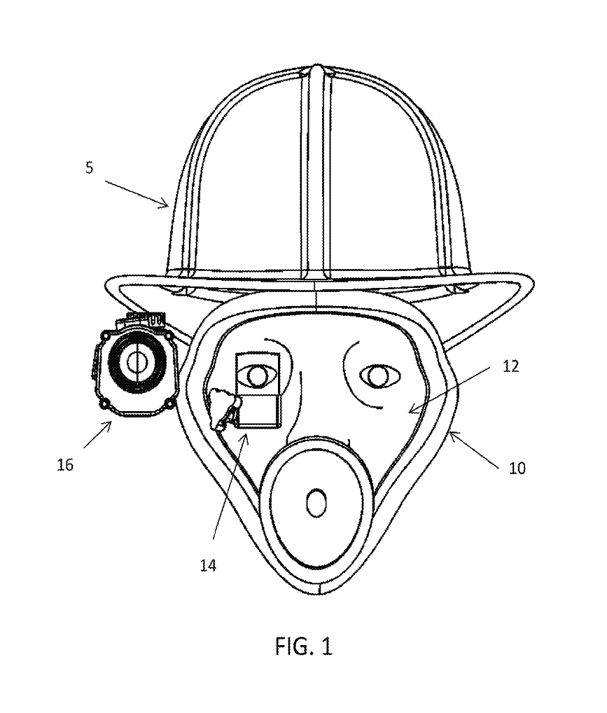

Referring to FIG. 1, in one embodiment of the present invention, the respiratory mask includes a frame 10, a face shield 12, and an internal see through display 14 which would cover one of the user's eyes. The respiratory mask may according to one embodiment be an off the shelf or custom modified respiratory mask, or a respiratory mask custom fitted with a transparent display 14 disposed inside the face shield 12. The respiratory mask is often worn with a protective helmet, but need not be integral to the helmet. Telemetry and other useful situational data may be wirelessly transmitted from a camera or other device 16 outside the face shield 12 to the display 14. The camera 16 according to such an embodiment may be an adjustable camera. The data interface between the camera and the display in such an embodiment can be configured with a wireless connection, such as Bluetooth or other suitable communication protocol. Alternatively, data may be transmitted through the face shield via optical or other means that allows for the transmission of data without compromising the seal of the mask.

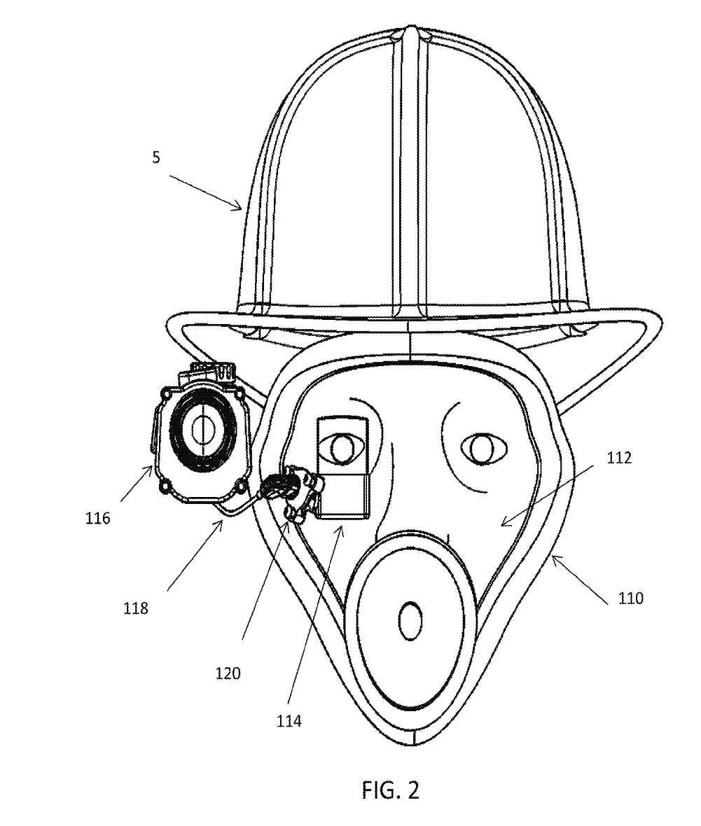

In alternative embodiments, the mask could be wired to permit transmission of data from external sources to the transparent display without compromising the seal of the respiratory mask to the face of the user. Referring to FIG. 2, according to one embodiment of the present invention, the respiratory mask includes a frame 110, a face shield 112, and an internal see through display 114 which would cover one of the user's eyes. In such an embodiment a removable external thermal imaging camera 116 is also be included. A cable connection 120 may be provided to couple the display 114 to the camera 116. The cable connection may be disposed in the face shield 112 as shown, or in the frame. A gasket, collar, caulking, or other suitable closure may be used to close the cable connection 120.

Thermal imaging cameras 16, 116, 216 of a variety of different types may be used. Data other than thermal imaging may be provided in some embodiments, examples of which can include telemetry data like self-location data, breathing apparatus status, target location data, camera and display battery life, environmental data.

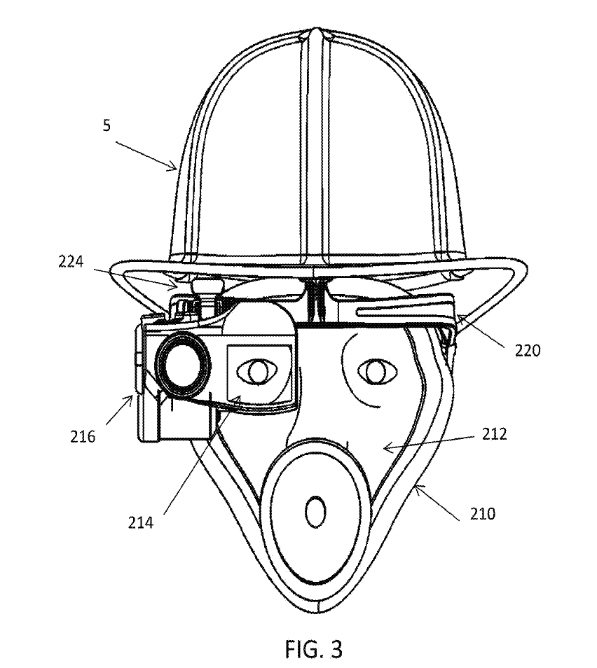

In other embodiments, such as that illustrated in FIG. 3, the respiratory mask includes a frame 210, a face shield 212, and an external see through display 214 which would cover one of the user's eyes. A removable external thermal imaging camera 216 is connected to the external outside of the display 214. As the display 214 and the camera are both located outside the display, they do not compromise the face shield 212 of the respiratory mask or self-contained breathing apparatus's seal integrity. In such an embodiment a removable rail mount 220 may be mounted to the exterior of the mask. The camera 216 may be mounted to the mask or to the protective helmet 5 or other suitable head mounted support. The camera may be equipped with mounting knobs or screws and adjustments 224 allowing the camera to be removed or adjusted. The camera and display can be modular in the sense that the may be detached from one mask and affixed to another without modifying either mask. Similarly, the data transmission of the display is unaltered by its transfer between masks. In embodiments where transparent displays are located externally to the lens, a conformable seal may be disposed between the lens and the display so that smoke and other atmospheric contaminants are substantially eliminated to the point where they do not interfere with the user's ability to see the lens.

Embodiments of the present invention may display information on the transparent display of information of a variety of types to allow a user access to the information in a convenient way without hindering activity by the user by occupying the users hands. Embodiments may provide information to the user via text or via color coding of the images.

A respiratory mask configured according to embodiments of the invention has the following advantages. It connects to multiple types/sizes of thermal imaging cameras (TICs) instead of a singularly coupled camera. It minimally compromises the protective facial lens. It projects telemetry and other useful situational data on to the transparent display via the same interface as the TIC. It mounts and connects to multiple types/sizes of transparent displays internal or external to the protective facial lens.

This specification is not intended to be exhaustive. Although the present application is shown in a limited number of forms, the scope of the invention is not limited to just these forms, but is amenable to various changes and modifications without departing from the spirit thereof. One of ordinary skill in the art should appreciate after learning the teachings related to the claimed subject matter contained in the foregoing description that many modifications and variations are possible in light of this disclosure. Accordingly, the claimed subject matter includes any combination of the above-described elements in all possible variations thereof, unless otherwise indicated herein or otherwise clearly contradicted by context. In particular, the limitations presented in dependent claims below can be combined with their corresponding independent claims in any number and in any order without departing from the scope of this disclosure, unless the dependent claims are logically incompatible with each other.

What is claimed is:

1. A system for the display of thermal data in a respiratory mask , the system comprising:
a first respiratory mask frame;
a lens disposed in said respiratory mask frame disposed in front of eyes of said user;
a transparent display, being detachably mounted to said respiratory mask and displaying thermal imaging data.

2. The system of claim 1 wherein said thermal data is provided to said transparent display by a thermal imaging camera disposed outside of said lens.

3. The system of claim 2 wherein said thermal imaging camera is head mounted.

4. The system of claim 3 wherein said thermal imaging camera is disposed on said frame.

5. The system of claim 1 wherein said transparent display receives said data wirelessly.

6. The system of claim 1 further comprising a wired connection between said transparent display and a source for said thermal imaging data.

7. The system of claim 6 further comprising a port through which said wired connection emerges from said mask.

8. The system of claim 7 further comprising a closure to said port.

9. The system of claim 6 wherein said wired connection is through said lens.

10. The system of claim 6 wherein said wired connection is through said frame.

11. The system of claim 1 wherein said fame is sealed to said user's face.

12. The system of claim 1 wherein said display displays information in addition to said thermal imaging data.

13. The system of claim 1 wherein said transparent display is configured to be detached from said first respiratory mask and attached to a second respiratory mask.

14. The system of claim 13 wherein said transparent display is detached form said first respiratory mask and attached to said second respiratory mask without modification of either said first or said second respiratory masks.

15. The system of claim 1 wherein said transparent display is disposed between at least one eye of a user and said lens.

16. The system of claim 1 wherein said wherein said transparent display displays telemetry data.

17. The system of claim 16, wherein said telemetry data is data selected from the group of data consisting of self-location data, breathing apparatus status, target location data, camera and display battery life, environmental data, and combinations thereof.

18. The system of claim 1 wherein said transparent display is disposed on a side of said lens opposite from a user's eye, and further comprising a compliant seal configured to conform to said lens and substantially exclude atmospheric contaminants between said display and said lens.
